(19) United States
(12) Patent Application Publication
(10) Pub. No.: US 2013/0327803 A1
(43) Pub. Date: Dec. 12, 2013

(54) LOAD CARRYING PACK SYSTEM

(71) Applicant: Charlie W. Chiang, Anaheim, CA (US)

(72) Inventor: Charlie W. Chiang, Anaheim, CA (US)

(21) Appl. No.: 13/489,660

(22) Filed: Jun. 6, 2012

(51) Int. Cl. A45C 15/00; B23P 17/04

(52) U.S. Cl. 224/582; 29/428

(57) ABSTRACT

Embodiments of a load carrying system and a method of providing a load carrying system include a first pack and a second pack defining a first load carrying configuration when the first pack and the second pack are usable separately and independent of each other to carry a corresponding load, and a second load carrying configuration when the first pack and the second pack are used together. Other embodiments may be described and claimed.

### FIELD

The present application generally relates to carry packs, and more particularly, to a load carrying pack system.

### BACKGROUND

Existing carryings systems, which may be backpacks, hydration packs, slings, hip packs or the like, have either a maximum cargo capacity or come with no pockets at all, such as hydration packs. Accordingly, a person may have to buy different sized bags for different situations. For example, the military personnel have 24 hour bags, 48 hour bags, and 72 hours bags, which as the names of these bags suggest, are used based on the duration of use of the bags. One bag may be too large or too small for various situations where weight and maneuverability are important. For example, weight and maneuverability are important in hiking and mountaineering. Therefore, one bag may be too large or too small for various situations, thereby requiring the purchase and use of multiple packs, which can become expensive.

### SUMMARY

According to one aspect, a load carrying system includes a first pack having at least one strap with a first section and a second section configured to be detachably connectable to form a loop for carrying the first pack. The load carrying system further includes a second pack having at least a first slot and a second slot extending through the second pack. The first pack and the second pack define a first load carrying configuration when the first pack and the second pack are usable separately and independent of each other to carry a corresponding load. The first pack and the second pack also define a second load carrying configuration when the first pack and the second pack are used together. In the second load carrying configuration, the first section of the at least one strap extends from inside the second pack through the first slot to outside the second pack and the second section of the at least one strap extends from inside the second pack through the second slot to outside the second pack. The first section of the at least one strap and the second section of the at least one strap are connected to form a loop for carrying the first pack and the second pack in the second load carrying configuration.

According to another aspect, a load carrying system includes a first pack having a first strap with a first section and a second section being detachably connectable to form a loop, and a second strap having a first section and a second section being detachably connectable to form a loop. The load carrying system further includes a second pack having a back panel and a first pair of slots and a second pair of slots extending through the back panel. The first pack and the second pack define a first load carrying configuration when the first pack and the second pack are usable separately and independent of each other to carry a corresponding load. The first pack and the second pack also define a second load carrying configuration when the first pack and the second pack are used together. In the second load carrying configuration, the first pack is located at least partly inside the second pack, each of the first and second sections of the first strap extends from inside the second pack through one of the slots of the first pair of slots to outside the second pack, and each of the first and second sections of the second strap extends from inside the second pack through one of the slots of the second pair of slots to outside the second pack. Also in the second load carrying configuration, the first section of the first strap and the second section of the first strap are connected to form a first loop for carrying the first pack and the second pack in the second load carrying configuration, and the first section of the second strap and the second section of the second strap are connected to form a second loop for carrying the first pack and the second pack in the second load carrying configuration.

According to another aspect, the first slot and the second slot may be located on a back panel of the second pack.

According to another aspect, the second pack may include a reinforcing structure at or proximate to each of the first slot and the second slot and configured to support each slot in the second load carrying configuration.

According to another aspect, the second pack may include a support sleeve at or proximate to each of the first slot and the second slot. Each of the first section and the second section of the at least one strap extends though the corresponding support sleeve in the second load carrying configuration.

According to another aspect, the second pack may include support straps at or proximate to each of the first slot and the second slot. Each of the first section and the second section of the at least one strap is attached to the corresponding support strap in the second load carrying configuration.

According to another aspect, the second pack includes a back panel having a first section and a second section. The second section is partly removable from the first section. The first slot and the second slot are in the second section.

According to another aspect, the second pack includes a back panel having a support structure configured to at least partly support a load carried in the second pack.

According to another aspect, the second pack includes a back panel having a support structure having at least one of vertically oriented or horizontally oriented support beams.

According to another aspect, a method of providing a load carrying system for a first pack and a second pack is disclosed. The first pack includes at least one strap with a first section and a second section configured to be detachably connectable to form a loop for carrying the first pack, and the second pack includes at least a first slot and a second slot extending through the second pack. The first pack and the second pack define a first load carrying configuration when the first pack and the second pack are usable separately and independent of each other to carry a corresponding load, and the first pack and the second pack define a second load carrying configuration when the first pack and the second pack are used together. The method includes inserting the first section of the strap from inside the second pack through the first slot to outside the second pack, inserting the second section of the strap from inside the second pack through the second slot to outside the second pack, and connecting the first section of the strap and the second section of the strap to form a loop for carrying the first pack and the second pack in the second load carrying configuration.

According to another aspect, the method of providing a load carrying system further includes inserting the first section of the strap through a first support sleeve located at or proximate to the first slot, and inserting the second section of the strap through a second support sleeve located at or proximate to the second slot.

According to another aspect, the method of providing a load carrying system further includes connecting the first section of the strap to a first support strap located at or proximate to the first slot, and connecting the second section of the strap to a second support strap located at or proximate to the second slot.

According to another aspect, inserting the first section of the strap from inside the second pack through the first slot to outside the second pack and inserting the second section of the strap from inside the second pack through the second slot to outside the second pack includes partly removing a second section of a back panel of the second pack from a first section of the back panel of the second pack. The first slot and the second slot are in the second section of the back panel. The method further includes inserting the first section of the strap through the first slot to outside the second pack and inserting the second section of the strap through the second slot to outside the second pack, and connecting the second section of the back panel to the first section of the back panel.

According to another aspect, the method of providing a load carrying system further includes inserting a first section of a second strap from inside the second pack through a third slot to outside the second pack, inserting a second section of the second strap from inside the second pack through a fourth slot to outside the second pack, and connecting the first section of the second strap and the second section of the second strap to form a loop for carrying the first pack and the second pack in the second load carrying configuration.

### BRIEF DESCRIPTION OF THE DRAWINGS

FIGS. 1-3 and FIGS. 4-6 show perspective views of a first load carrying pack and a second load carrying pack, respectively, of a load carrying system according to one embodiment.

FIGS. 7-9 show perspective views of assembling the first pack and the second pack of FIG. 1.

FIGS. 10-12 show another embodiment of the second pack of FIG. 1.

FIG. 13 is a cross-sectional view of a load carrying system according to the embodiments of FIGS. 1-12.

FIGS. 14-16 show the second pack of FIGS. 4-6 being prepared to be stowed away.

FIGS. 17-19 show various methods by which the second pack of FIGS. 4-6 is stowed away on the first pack of FIGS. 1-3.

FIG. 20 shows a cross-sectional view of a load carrying system according to another embodiment.

FIG. 21 is a perspective view of the load carrying system of FIG. 20.

FIGS. 22-24 show one embodiment for compacting the second pack of FIGS. 20 and 21.

FIG. 25 is a side view of a load carrying system according to another embodiment.

FIG. 26 is a perspective view of the load carrying system of FIG. 25.

FIGS. 27 and 28 are perspective views of the second pack of the load carrying system of FIG. 25.

FIGS. 29 and 30 show assembly of the load carrying system of FIG. 25.

FIGS. 31 and 32 show a load carrying system according to another embodiment.

FIGS. 33 and 34 show a load carrying system according to another embodiment.

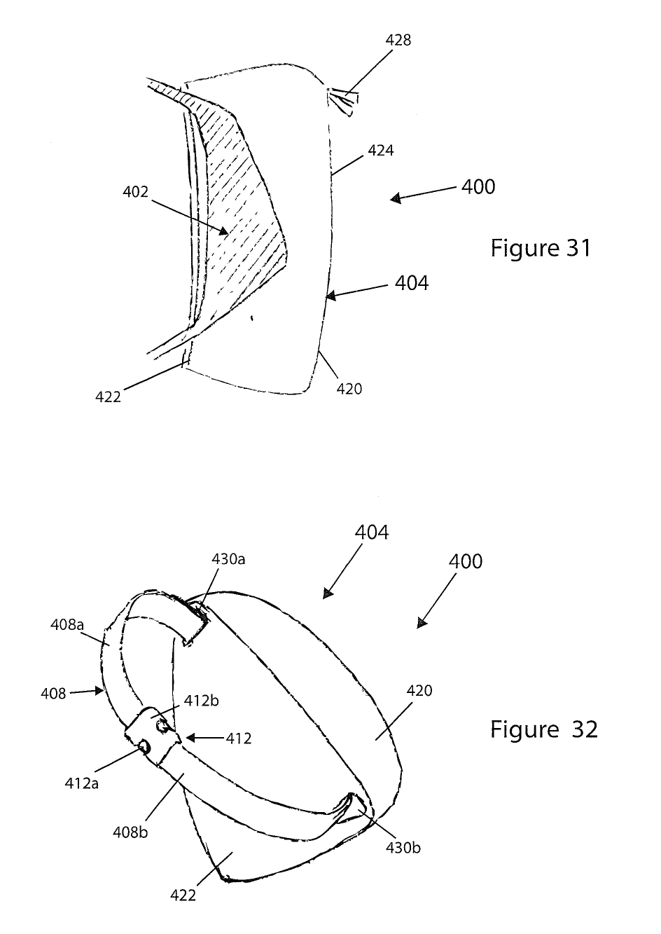

FIGS. 31 and 32 show a load carrying system according to another embodiment.

FIGS. 35-37 show a reinforcing device for use with load carrying systems according to the disclosure.

FIGS. 38 and 39 show another reinforcing device for use with load carrying systems according to the disclosure.

FIGS. 40-42 show another reinforcing device for use with load carrying systems according to the disclosure.

### DETAILED DESCRIPTION

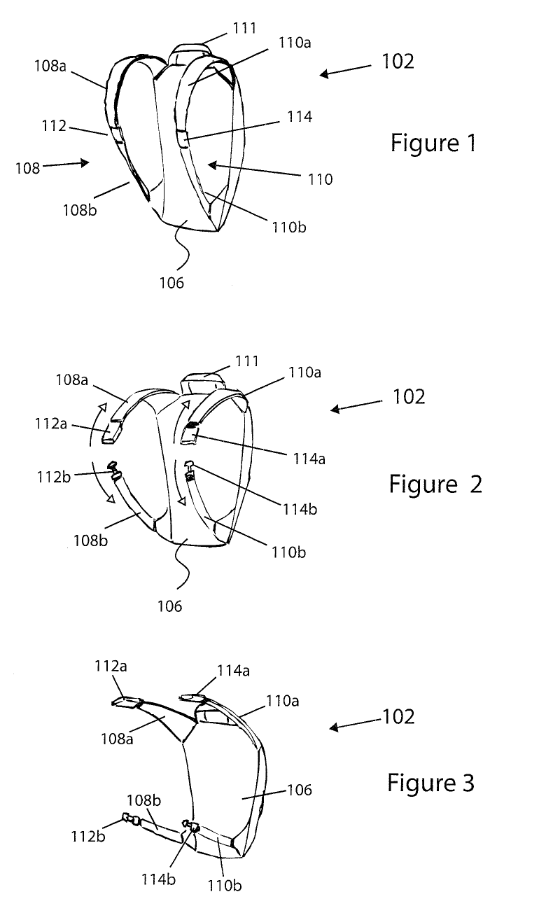

FIGS. 1-9 show a load carrying system 100 according to one embodiment. The load carrying system 100 includes a first pack 102 and a second pack 104. As described in detail below, the first pack 102 and the second pack 104 can be assembled and connected to form the load carrying system 100, which can be carried on a person's back and/or shoulders.

Referring to FIGS. 1-3, the first pack 102 includes a body 106 defining one or more storage compartments, a shoulder strap 108 on the right side (i.e., corresponding to the right side of the person using the pack) of the body 106, and a shoulder straps 110 on the left side (i.e., corresponding to the right side of the person using the pack) of the body 110. The pack 102 may be a backpack that is commonly used to carry various items on a person's back. The pack 102 may also be a type of pack that is used to carry water for consumption by the person carrying the pack. The person carrying the pack can drink the water through a tube that is connected to a water reservoir in the body 106. Such a pack is typically referred to as a hydration pack. An example of such a pack is manufactured by CamelBak Products, LLC of Petaluma, Calif. In FIGS. 1-9, the first pack 102 is shown to be a hydration pack and may be referred to herein as the hydration pack 102. However, the disclosure is not limited to the first pack 102 being a particular type of pack such as a hydration pack.

The first pack 102 may also include a handle 111, by which a person can lift, move and/or carry the pack 102. Each strap 108 and 110 includes an upper strap section 108a and 110a and a lower strap section 108b and 110b, respectively. The upper strap section 108a is connected or attached at one end to the upper right portion of the body 106. At the opposite and, the upper strap section 108a includes a first mating part 112a of a fastener 112. The lower strap section 108b is connected or attached at one end to the lower right portion of the body 106. At the opposite end, the lower strap section 108b includes a second mating part 112b of the fastener 112. The strap 108 forms a loop with the body 106 when the first mating part 112a and the second mating part 112b are mated or connected.

The upper strap section 110a is connected or attached at one end to the upper left portion of the body 106. At the opposite end, the upper strap section 110a includes a first mating part 114a of a fastener 114. The lower strap section 110b is connected or attached at one end to the lower left portion of the body 106. At the opposite end, the lower strap section 110b includes a second mating part 114b of the fastener 114. The strap 110 forms a loop with the body 106 when the first mating part 114a and the second mating part 114b are mated or connected.

Each of the fasteners 112 and 114 can be any type of fastener that is used to connect to flexible parts. For example, the fasteners 112 and 114 may be clip-type fasteners that are commonly used in backpacks to connect two straps. In such fasteners, the first mating fasteners 112a and 114a may be formed by a female plastic part configured to receive the second mating fasteners 112b and 114b, respectively, which may be correspondingly sized male plastic parts. The second mating fasteners 112b and 114b may include flexible tabs (not shown) that compress when the second mating fasteners 112b and 114b are inserted into the first mating fasteners 112a and 114a. The first mating fasteners 112a and 114a can include slots (not shown) that receive the tabs, such that the tabs snap into the slots to lock the second mating fasteners 112b and 114b into the first mating fasteners 112a and 114 a, respectively. The above-described fastener is only an exemplary fastener that can be used for the fasteners 112 one 114 and in no way limits the type of fastener that can be used for the fasteners 112 and 114. Any fastener that can connect and secure the two sections 108a and 108b or the two sections 110a and 110b can be used in the first pack 102. For example, the fasteners 112 and 114 may be belt-type fasteners. The noted belt-type fastener typically includes a buckle with a pin for engaging spaced apart holes in a strap. In yet another example, the fasteners 112 and 114 may be frictional belt-type fasteners. The noted belt-type fastener typically includes a buckle with one or more ribbed or roughened surfaces that frictionally engage a strap to securely maintain the strap in the buckle.

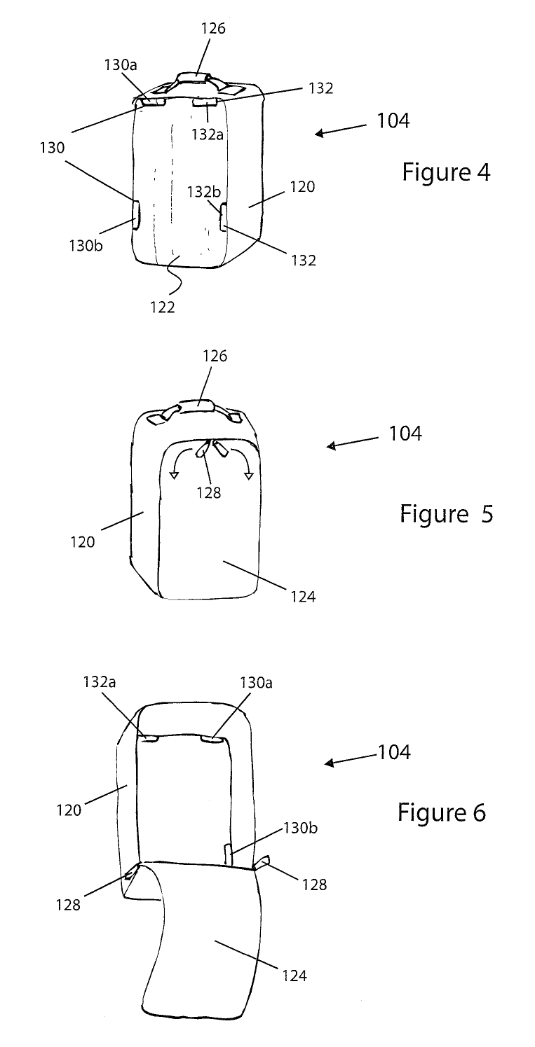

Referring to FIGS. 4-6, the second pack 104 includes a body 120 defining one or more storage compartments. The body 120 includes a back panel 122 and a front panel 124. The second pack 104 may also include a handle 126 anywhere on the second pack 104 to facilitate lifting, moving, and/or carrying the second pack 104. Access to the interior of the body 120 can be provided by an opening in the front panel 124, or at least partial removal of the front panel 124 from the body 120. In the examples of FIGS. 4-6, the front panel 124 can be partially removed from the body 120 with a zipper 128. The zipper 128 may be located anywhere on the body 120 to allow access to the interior of the body 120. In the example shown in 5 and 6, the zipper 128 is located on three sides of the front panel 124, thereby allowing access to the entire interior of the body 120 as shown in FIG. 6.

The back panel 122 includes two slots 130 on the right side (i.e., corresponding to the right side of the person using the pack) and two slots 132 on the left side (i.e., corresponding to the left side of the person using the pack). The back panel 122, can be made of ballistic nylon, nylon mesh, cotton, linen, rip-stop polyester, neoprene, or any type of fabric that may be suitable for use in a particular pack depending on the purpose of thatpack. The material of each panel (e.g. back, front, side, top, bottom, flaps) may be different. The one or more materials for each panel may be chosen so as to be suitable for each panel depending on the purpose and/or the operating location or environment of a pack. For example, the top of the pack may need to be smooth. Accordingly, a rip-stop polyester may be best suited while the bottom may best be served with a ballistic nylon coated with rubber.

The term slot as used herein does not limit the shape, size and/or configuration of the openings which define the slots. The openings defining the slots may be in any configuration. The two slots 130 include an upper right slot 130a and a lower right slot 130b. The two slots 132 include an upper left slot 132a and a lower left slot 132b. The slots 130a, 130b, 132a, and 132b extend through the back panel 122 so as to provide openings from the interior of the body 120 to the outside of the body 120. The slots 130a, 130b, 132a, and 132b are configured to accommodate insertion of the straps 108 and 110 of the first pack 102 as described in detail below. The slots can also be made large enough to accommodate hip belts that are typically provided on hiking or mountain packs. Certain hiking or mountain packs include a rigid internal frame or a rigid external frame. For hiking or mountain packs with hard external frames, additional slots may be provided to accommodate portions of the hard external frames.

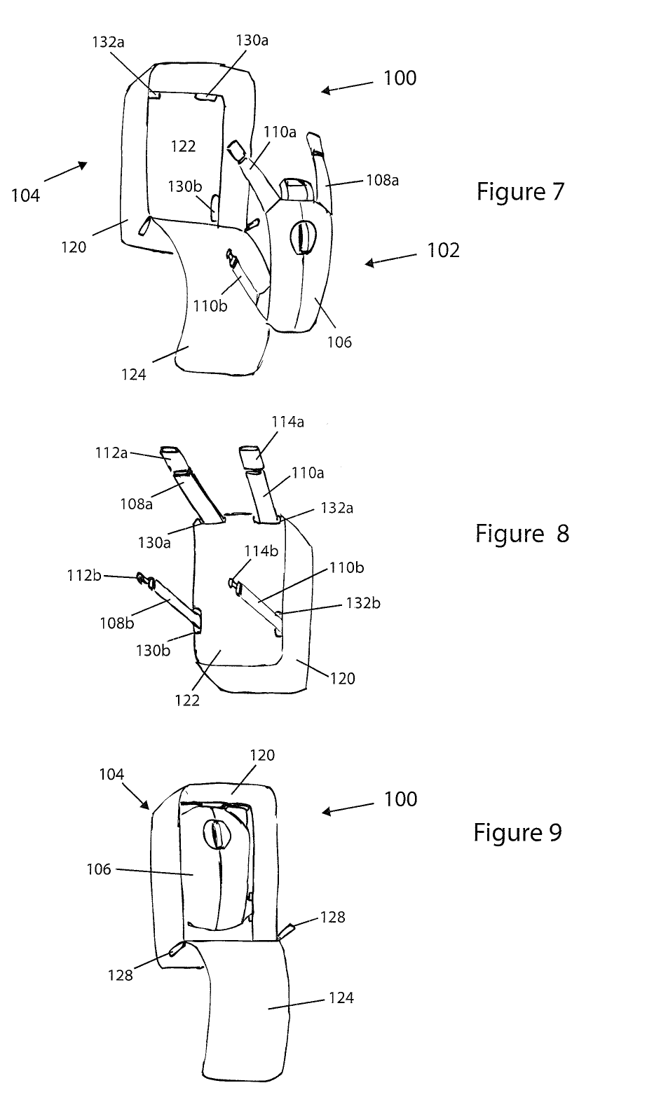

Referring to FIGS. 7-9, assembly of the first pack 102 with a second pack 104 to form the load carrying system 100 is shown. A person provided with the load carrying system 100 can use the first pack 102 to carry objects inside the body 106. Alternatively, the first pack 102 can be a hydration pack 102. A person can support the first pack 102 on his back by using the straps 108 and 110. The pack 104 is an optional feature of the load carrying system 100 that may be used when needed. Accordingly, as will be described in detail below, the pack 104 may be stowed when not in use. When the person wishes to use the second pack 104, he or she can assemble the pack 102 with the pack 104 to form the load carrying system 100. To do so, the front panel 124 of the second pack 104 is opened with the zipper 128 to provide full access to the interior of the second pack 104 as shown in FIG. 7. To assemble first pack 102 with the second pack 104, the fastener 112 is unfastened to separate the strap 108 into strap sections 108a and 108b. Similarly, the fastener 114 is unfastened to separate the strap 110 into strap sections 110a and 110b. Subsequently, each strap section is inserted into a corresponding one of the slots in the back panel 122 of the second pack 104. As shown in FIGS. 8 and 9, each strap section 108a, 108b, 110a and 110b is inserted into and passed through a corresponding slot 130a, 130b, 132a and 132b, respectively, from inside of the body 120 of the second pack 104. As shown in FIG. 9, the straps are then fully pulled through their corresponding slots until the first pack 102 is completely inside the second pack 104 and abuts the inner side of the back panel 122 of the second pack 104. Accordingly, in the embodiments of FIGS. 1-9, the first pack 102 should preferably be smaller or at most be nearly the same size as the interior dimensions of the back panel 122 so that the first pack 102 can fit inside the second pack 104 as described above. To complete the assembly process, the first mating parts 112a and 114a are connected or mated to the second mating parts 112b and 114b, respectively, to secure the fasteners 112 and 114. Thus, the straps 108 and 110 for complete loops with the back panel 122 of the second pack 104. The person can then carry both packs 102 and 104 with the shoulder straps 108 and 110, while utilizing the load carrying capabilities of both packs 102 and 104.

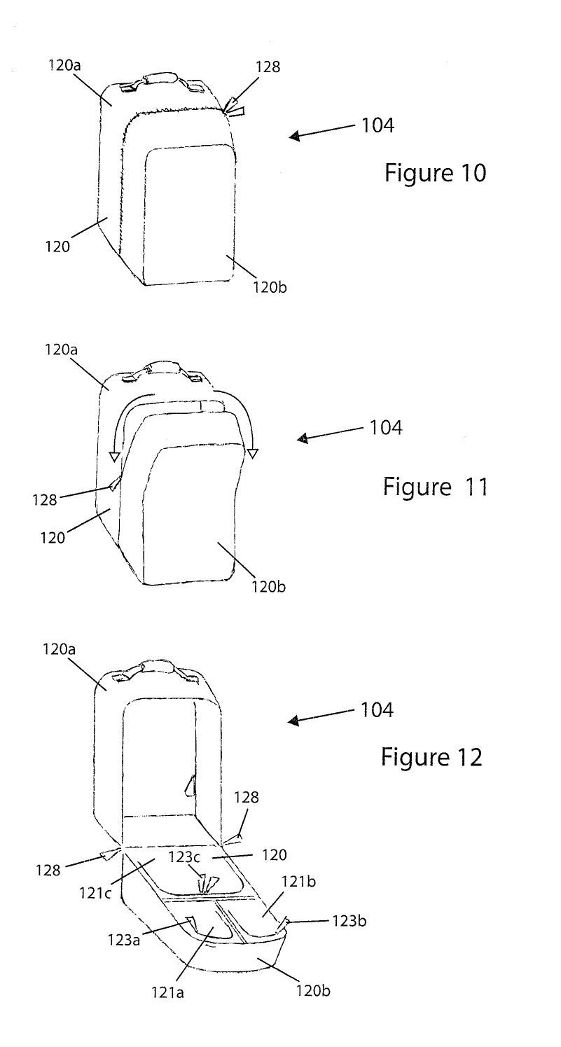

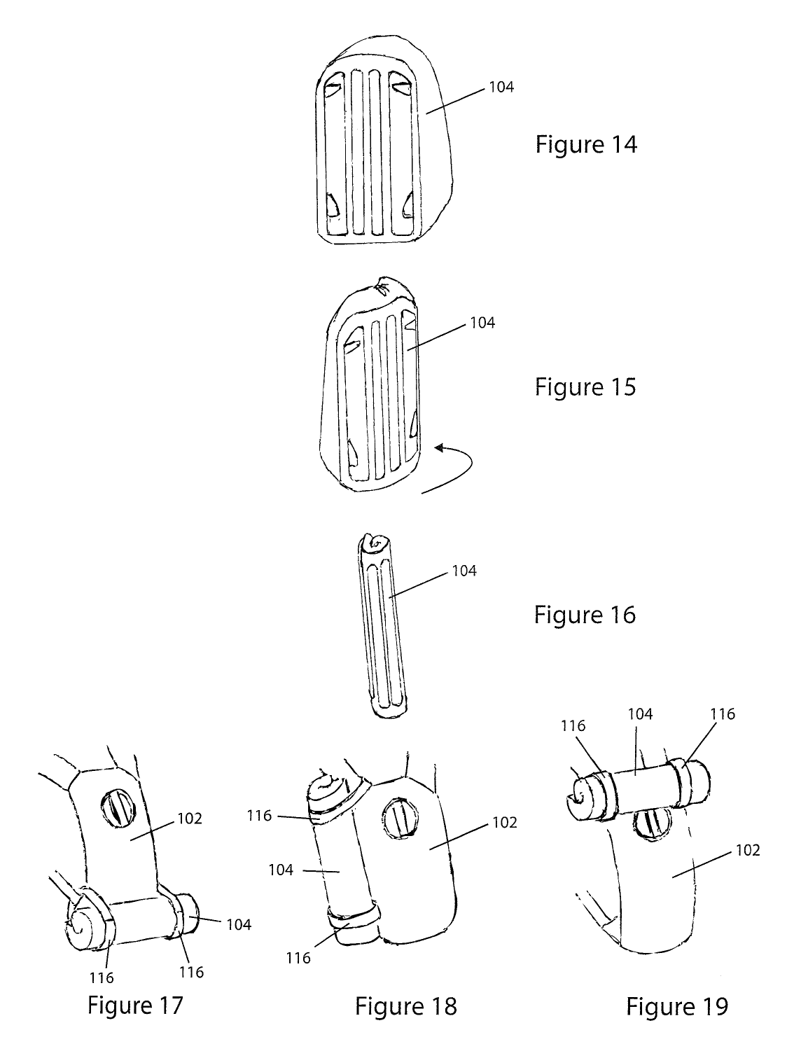

Referring to FIGS. 10-12, the zipper 128 may be on the body 120 instead of between the front panel 124 and the body 120. Accordingly, the zipper 128 divides the body 120 into a rear pack section 120a and a front pack section 120b. As shown in FIG. 11, the zipper 128 can be partially opened to provide partial access to the interior of the second pack 104. As shown in FIG. 12, however, the zipper 128 can be fully opened to provide full access to the interior of the pack 104. Each of the rear and front sections 120a and 120b may include one or more storage pockets or compartments. In the example of FIG. 12, the front pack section 120b is shown to have three storage compartments 121a, 121b and 121c, each of which is accessible with a zipper 123a, 123b and 123c, respectively. However, the number, size, and shape of internal and external compartments may vary depending on the function or purpose of a pack. Compartments can be made of mesh, nylon, polyester, cotton, linen, neoprene, or any material that may better suit the purpose of the compartment. Although not shown, the second pack 104 can have one or more compartments in the rear pack section 120a, the front pack section 120b, or in both pack sections. Alternatively, the second pack 104 can be similar to the second pack of FIG. 6, which has no internal compartments. For example, versions of the second pack 104 for use by military personnel may require pouches for magazines. Military versions of the second pack 104 may also require PALS straps so that it can be used with other equipment with PALS attachments. PALS straps are described in detail in U.S. Pat. No. 5,724,707. When the first pack 102 is a hydration pack and is used by runners who only require enough space for snacks and supplements, the second pack 104 may be small to accommodate a few snacks and supplements. Versions of the second pack 104 for athletes who would like to carry layers of clothing may be larger.

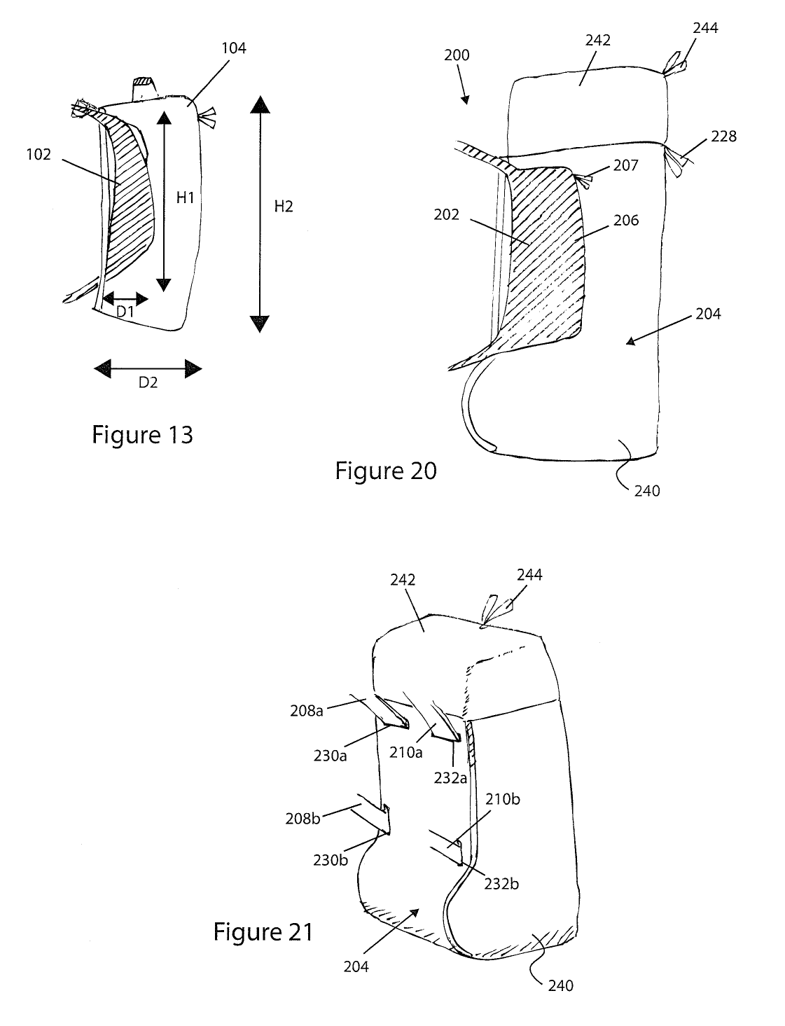

Referring to FIG. 13, the height H2 and the depth D2 of second pack 104 is greater than the depth D1 of the pack 102 when pack 102 is filled. Accordingly, even if a fully loaded first pack 102 is inserted into the second pack 104, the second pack 104 may have sufficient storage volume for holding equipment, gear, and other objects that the person may wish to store in the second pack 104. Thus, when the first pack 102 is inserted into the second pack 104 to form the load carrying system 100, the second pack 104 can be used in the same manner as when the second pack 104 is used alone without the first pack 102. However, some of the storage volume in the second pack 104 will be used by the first pack 102.

FIGS. 14-19 show different methods by which the second pack 104 can be stowed and carried with the first pack 102. The second pack 104 is shown in FIG. 14 to have a thicker or semi-rigid back panel 122. However, the back panel 122 may be sufficiently flexible to allow the second pack 104 to be rolled up as shown in FIGS. 15 and 16. Upon rolling up the second pack 104, the second pack 104 can be attached to the first pack 102 with straps 116. The straps 116 can be tightened to securely hold the second pack 104 on the first pack 102 and to further compress the second pack 104 if necessary. The straps 116 may be located anywhere on the first pack 102. In FIGS. 17 and 19, the straps 116 are located on top and on the bottom of the first pack 102, respectively, to provide a symmetric position and load for the second pack 104. However, as shown in FIG. 18, the straps 116 may be positioned on one side of the first pack 102 for securing the second pack 104 to the first pack 102.

FIGS. 20 and 21 show a load carrying system 200 according to another embodiment. The load carrying system 200 is similar in many respects to the load carrying system 100 described above, in that it includes a first pack 202 and a second pack 204 that can be assembled to form the load carrying system 200. The first pack 202 includes strap sections 208a, 208b and 210a, 210b, which can be inserted into corresponding slots 230a, 230b and 232a, 232b, respectively, of the back panel 222 of the second pack 204. In the embodiment of FIGS. 20 and 21, however, the first pack 202 is shown to be a typical backpack, which has a body 206 that is accessible through a front panel with a zipper 207. However, the first pack 202 may be a hydration pack. Furthermore, the second pack 204 includes a large lower compartment 240, which is accessible with a zipper 228 and an upper compartment 242, which may be a separate compartment and may be separately accessible by a zipper 244.

A person using the load carrying system 200 can use the first pack 202 alone to carry gear when the first pack 202 provides sufficient load carrying volume. If more load carrying volume is needed, the person can use the second pack 204, which may be stowed in any manner. For example, the second pack 204 can be rolled up and securely held on the first pack 202 with straps (not shown) similar to the method described and shown in FIGS. 14-19. Assembly of the first pack 202 inside the second pack 204 can be performed similar to the assembly described with respect to the load carrying system 100.

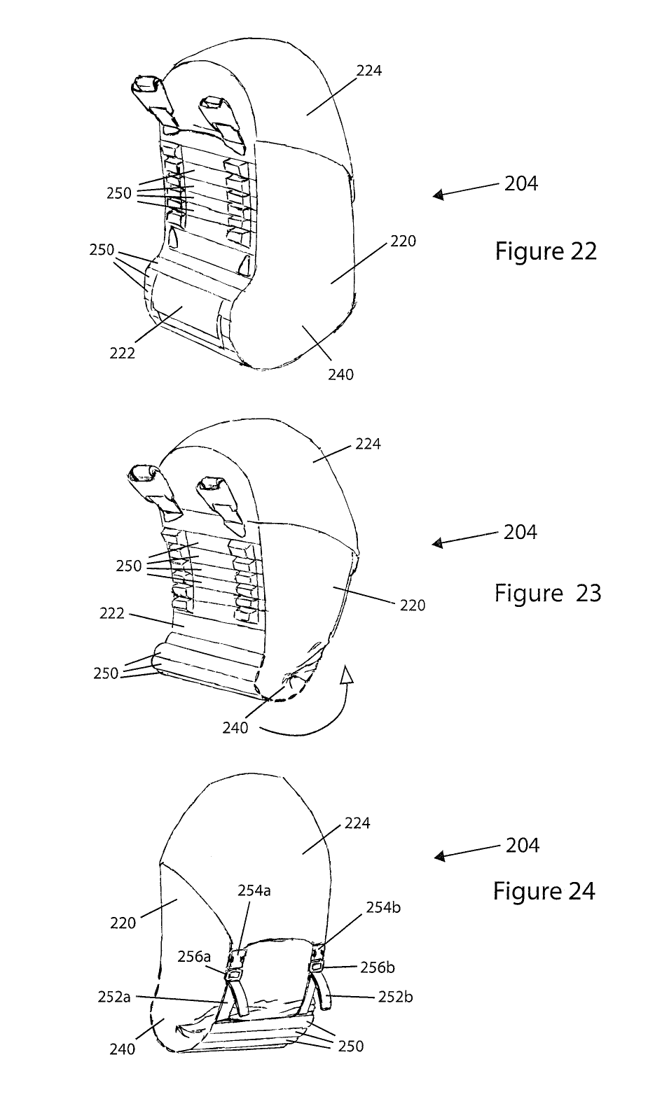

Referring to FIGS. 22-24, another example of the second pack 204 is shown. The second pack 204 includes structural support on the back panel 222. The structural support may be in the form of a plurality of plates 250 that are arranged horizontally on the back panel 222 adjacent to each other and are horizontally spaced apart. The space between the plates 250 allows the plates 250 to move relative to each other. However, excessive movement of each plate 250 may cause the plate to abut against an adjacent plate and prevent the excessive movement, hence providing additional structural support. The plates 250 may be constructed from substantially rigid materials such as aluminum or composite materials. However, the plates 50 may be constructed from less rigid materials such as variety of plastics. The plates may also be constructed from foam, neoprene or thick sections of fabric. The plates 250 provide structural support for a person using the second pack 204, and in particular, when the second pack 204 is heavily loaded. The weight of the pack 204 may be at least partly transferred to the plates 250, with each plate in turn transferring some of the forces to adjacent plates to distribute the weight. In other embodiments, vertical supports may be better suited for structural reinforcement as shown in FIGS. 14-16. Such vertical supports may be limitedly moveable relative to each other to also offer flexibility. However, such vertical supports may also be rigidly attached to each other to form a rigid frame.

When the second pack 204 is lightly loaded, a person carrying the pack 204 may wish to reduce the size of the second pack 204 in order to reduce interference of the second pack 204 with the person's body or with objects by which the person may encounter. To reduce the size of the second pack 204, the pack 204 may include two straps 252a and 252b on the bottom of the pack 204 outside the lower compartment 240 or on the lower portion of the back panel 222. As shown in FIG. 24, each of the straps 252a and 252b includes a mating fastener (not shown) at the end thereof that connects with a correspondingly configured mating fastener 254a and 254b, respectively, located on the front panel 224. Each strap 252a and 252b includes an adjustment loop or buckle 256a and 256b, respectively, for adjusting the length of the strap. As shown in FIG. 24, the straps 252a and 252b can be pulled from the back side of the pack 204 toward the front panel 224 and fastened with the fasteners 254a and 254b, respectively. Because each of the plates 250 is spaced apart from an adjacent plate, the back panel 222 including the lower compartment 240 is flexible so as to allow the lower compartment 240 to be compacted and pulled toward the front panel 224. In other words, each plate 250 is independently movable relative to an adjacent plate along the space between the plates 250. The degree by which the second pack 204 is compacted may be controlled by adjusting the length of the straps 252a and 252b. As shown in FIG. 24, the ends of the straps can be pulled to the maximum extent possible in order to provide a maximum degree of compactness for the lower compartment 240. Alternatively, the straps 252a and 252b can be adjusted to provide a small degree of compactness for the lower compartment 240. Thus, even with the substantially rigid or semi-rigid structural support provided by the plates 250, a person can compact the lower compartment 240 when not in use or can adjust the size of the lower compartment 240 depending on the contents of the second pack 204. As described above, the adjustment of the size of the lower compartment 240 is possible due to the independent structural support function provided by the plates 250 and the space provided between each plate 250.

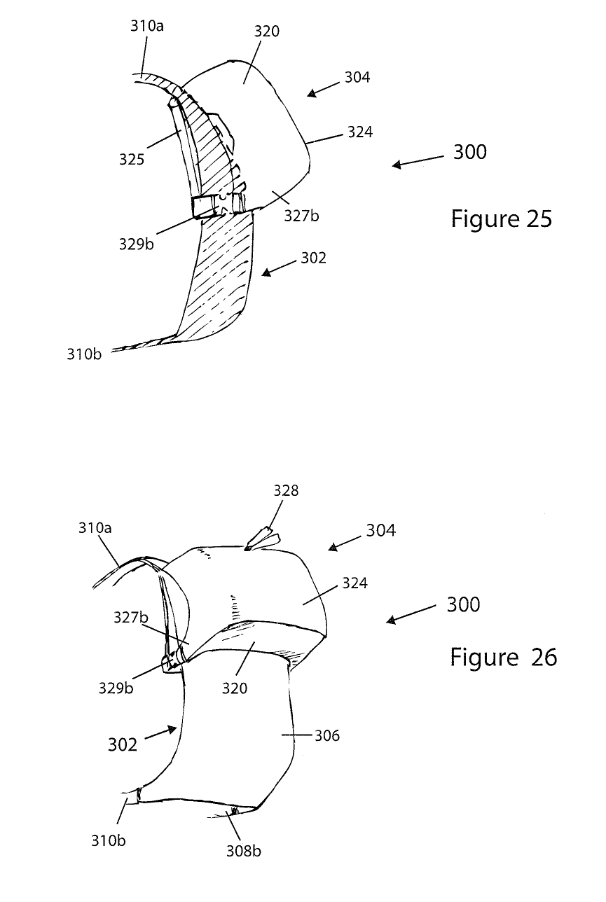

Referring to FIGS. 25-30, a load carrying system 300 according to another embodiment is shown. The load carrying system 300 includes a first pack 302 and a second pack 304 The first pack 302 includes a body 306 defining one or more storage compartment, a shoulder strap 308 on the right side (i.e., corresponding to the right side of the person using the pack) of the body 306, and a shoulder straps 310 on the side (i.e., corresponding to the right side of the person using the pack) of the body 310. The pack 302 may be a backpack that is commonly used to carry various items on a person's back. The pack 302 may also be a hydration pack. In FIGS. 25-30, the first pack 302 is shown to be a hydration pack and may be referred to herein as the hydration pack 302. However, the disclosure is not limited to the type of pack that is used as the first pack 302 as long as the first pack 302 includes the functional and other features described herein.

Each strap 308 and 310 includes an upper strap section 308a and 310a and a lower strap section 308b and 310b, respectively. The upper strap section 308a is connected or attached at one end to the upper right portion of the body 306. At the opposite and, the upper strap section 308a includes a first mating part 312a of a fastener 312. The lower strap section 308b is connected or attached at one end to the lower right portion of the body 306. At the opposite end, the lower strap section 308b includes a second mating part 312b of the fastener 312. The strap 308 forms a loop with the body 306 when the first mating part 312a and the second mating part 312b are mated or connected.

The upper strap section 310a is connected or attached at one end to the upper left portion of the body 306. At the opposite end, the upper strap section 310a includes a first mating part 314a of a fastener 314. The lower strap section 310b is connected or attached at one end to the lower left portion of the body 306. At the opposite end, the lower strap section 310b includes a second mating part 314b of the fastener 314. The strap 310 forms a loop with the body 306 when the first mating part 314a and the second mating part 314b are mated or connected. The fasteners 312 and 314 may be similar to the fasteners 112 and 114 of the load carrying system 100.

The second pack 304 includes a body 320 defining one or more storage compartments. A first section 321 of the body 320 includes a back panel 322, a front panel 324. Access to the interior of the first section 321 body 320 can be provided by an opening in the front panel 324, or at least partial removal of the front panel 324 from the body 320. The front panel 324 includes a zipper 328 for providing access to the interior of the body 320. The zipper 128 may be located anywhere on the body 320 to allow access to the interior of the body 320. The second pack 304 includes an outer panel 325, which defines a second section 323 of the body 320 with the back panel 322. The second section 323 of the body 320 may be used for storage of different items.

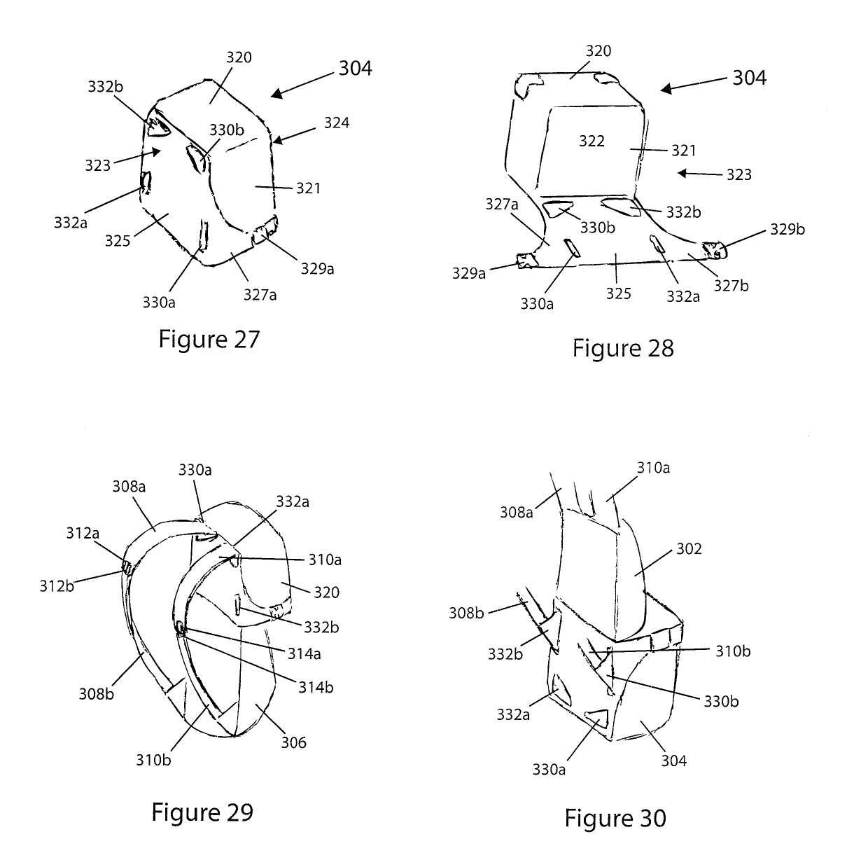

The outer panel 325 is used to assemble the first pack 302 and the second pack 304 to form the load carrying system 300 as described below. The outer panel 325 is attached to the back panel 322 or to the first section 321 at one edge so as to function as a removable flap as shown in FIGS. 27 and 28. The outer panel 325 is shown in FIGS. 27 and 28 to be attached at one edge to the top section of the back panel 322. At the corners of the opposite edge, the outer panel 325 includes two side panels 327a and 327b. Each of the side panels 327a and 327b can be tightly wrapped around a corresponding side of the first section 321 and fastened to the first section with fasteners 329a and 329b, respectively. Accordingly, when fastened, the outer panel 325 is tightly secured to the back panel 322 and the first section 321.

The outer panel 325 includes two slots 330 on the right side (i.e., corresponding to the right side of the person using the pack) and two slots 332 on the left side (i.e., corresponding to the left side of the person using the pack). The two slots 330 include an upper right slot 330a and a lower right slot 330b. The two slots 332 include an upper left slot 332a and a lower left slot 332b. The slots 330a, 330b, 332a, and 332b extend through the outer panel 325 so as to provide openings from one side of the outer panel 325 to the other side of the outer panel 325. The slots 330a, 330b, 332a, and 332b are configured to accommodate insertion of the straps 308 and 310 of the first pack 302 as described in detail below.

A person provided with the load carrying system 300 can use the first pack 302 to carry objects inside the body 306. Alternatively, the first pack 302 can be a hydration pack 302. A person can support the first pack 302 on his back by using the straps 308 and 310. The pack 304 is an optional feature of the load carrying system 300 that may be used when needed. Accordingly, as will be described in detail below, the pack 304 may be stowed when not in use. When the person wishes to use the second pack 304, he or she can assemble the pack 302 with the pack 304 to form the load carrying system 300 as described below.

To assemble the first pack 302 with the second pack 304, the fasteners 329a and 329b of the outer panel 325 are unfastened to partly detach the outer panel 325 from the first section 321, except for the upper edge of the outer panel 325. Referring to FIG. 29, the straps 308a and 310a are passed and pulled through the slots 330a and 332a of the outer panel 325 to place the upper portion of the first pack 302 in the second section 323 of the second pack 304, i.e., between the back panel 322 and the outer panel 325. The side panels 327a and 327b are pulled and wrapped around the sides of the first pack 302 and the sides of the first section 321 of the second pack 304 and fastened to the first section 321 with fasteners 329a and 329b. As shown in FIG. 29, upon completion of the above-described assembly, the first pack 302 and the second pack 304 are securely connected by the second pack 304 being attached to the first pack 302 in a piggy-back configuration to form the load carrying system 300.

FIG. 30 shows another exemplary configuration of the load carrying system 300. In FIGS. 25-29, the second pack 304 is connected to an upper portion of the first pack 302. In FIG. 24, however, the second pack 304 is connected to a lower portion of the first pack 302. To assemble the first pack 302 and the second pack 304 as shown in FIG. 30, the fasteners 329a and 329b of the outer panel 325 are unfastened to partly detach the outer panel 325 from the first section 321, except for the upper edge of the outer panel 325. The straps 308b and 310b are passed and pulled through the slots 330b and 332b of the outer panel 325 to place the lower portion of the first pack 302 in the second section 323 of the second pack 304, i.e., between the back panel 322 and the outer panel 325. The side panels 327a and 327b are pulled and wrapped around the sides of the first pack 302 and the sides of the body 320 of the second pack 304 and fastened to the body 320 with fasteners 329a and 329b. As shown in FIG. 30, upon completion of the above-described assembly, the first pack 302 and the second pack 304 are securely connected by the second pack 304 being attached to the first pack 302 at a lower portion of the first pack 302.

FIGS. 31 and 32 show a load carrying system 400 according to another embodiment. The load carrying system 400 includes a first pack 402 and a second pack 404. As described in detail below, the first pack 402 and the second pack 404 can be assembled and connected to form a load carrying system, which can be carried on a person's back and/or shoulders. The first pack 402 includes a body 406 defining one or more storage compartment, and a shoulder strap 408. The pack 402 may be shoulder bag that is commonly used to carry various items. Because the first pack 402 has only on strap 408, it may be carried on a person's shoulder or carried so that the strap is diagonally positioned on the person's chest and back. The strap 408 includes an upper strap section 408a and a lower strap section 408b. The upper strap section 408a is connected or attached at one end to the upper portion of the body 406. At the opposite and, the upper strap section 408a includes a first mating part 412a of a fastener 412. The lower strap section 408b is connected or attached at one end to the lower right or left portion of the body 406. At the opposite end, the lower strap section 408b includes a second mating part 412b of the fastener 412. The strap 408 forms a loop with the body 406 when the first mating part 412a and the second mating part 412b are mated or connected. The fastener 412 may be similar to the fastener 112 or 114 of the load carrying system 100.

The second pack 404 includes a body 420 defining one or more storage compartments. The body 420 includes a back panel 422 and a front panel 424. Access to the interior of the body 420 can be provided by an opening in the front panel 424, or at least partial removal of the front panel 424 from the body 420. For example, the front panel 424 may be partially removed from the body 420 with a zipper 428. The zipper 428 may be located anywhere on the body 420 to allow access to the interior of the body 420. The zipper 428 may be located on three sides of the front panel 424, thereby allowing access to the entire interior of the body 420.

The back panel 422 includes an upper slot 430a and a lower slot 430b. The slots 430a and 430b extend through the back panel 422 so as to provide openings from the interior of the body 420 to the outside of the back panel 422. The slots 430a and 430b are configured to accommodate insertion of the strap 408 of the first pack 402 as described in detail below.

A person provided with the load carrying system 400 can use the first pack 402 to carry objects inside the body 406. The second pack 404 is an optional feature of the load carrying system 400 that may be used when needed. Accordingly, the second pack 404 may be stowed when not in use. When the person wishes to use the second pack 404, he or she can assemble the pack 402 with the pack 404 to form the load carrying system 400. To do so, the front panel 424 of the second pack 404 is opened with the zipper 428 to provide full access to the interior of the second pack 404. To assemble first pack 402 with the second pack 404, the fastener 412 is unfastened to separate the strap 408 into strap sections 408a and 408b. Subsequently, the strap sections 408a and 408b are inserted and passed through the slots 430a and 430b, respectively, from the inside of the body 420 of the second pack 404. The straps are fully pulled through their corresponding slots until the first pack 402 is completely inside the second pack 404 and abuts the inner side of the back panel 422 of the second pack 404. Accordingly, the first pack 402 should preferably be smaller or at most be nearly the same size as the interior dimensions of the back panel 422 so that the first pack 402 can fit inside the second pack 404 as described above. To complete the assembly process, the first mating part 412a is connected or mated to the second mating part 412b to secure the fastener 412. Thus, the strap 408 completes a loop with the back panel 422 of the second pack 404. The person can then carry both packs 402 and 404 with the shoulder strap 408, while utilizing the load carrying capabilities of both packs 402 and 404.

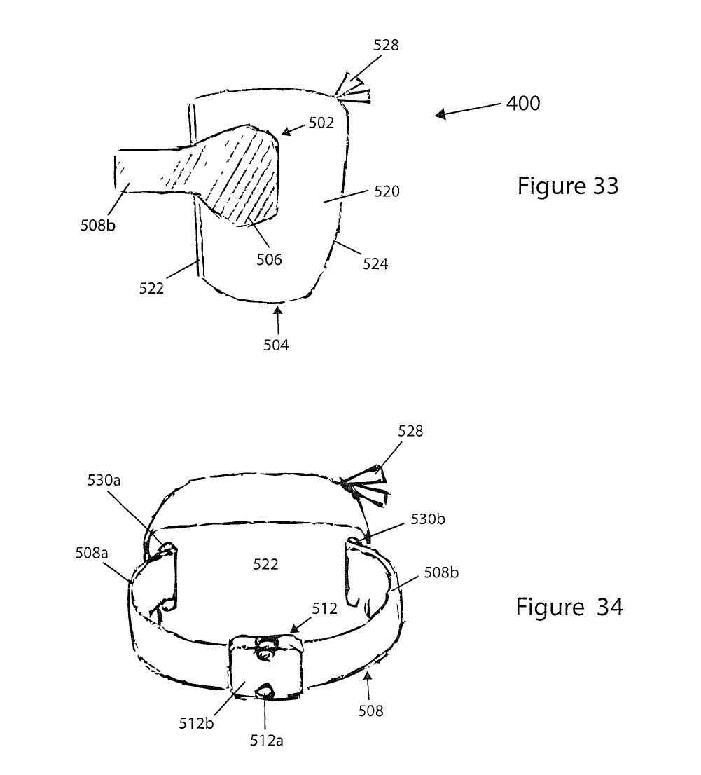

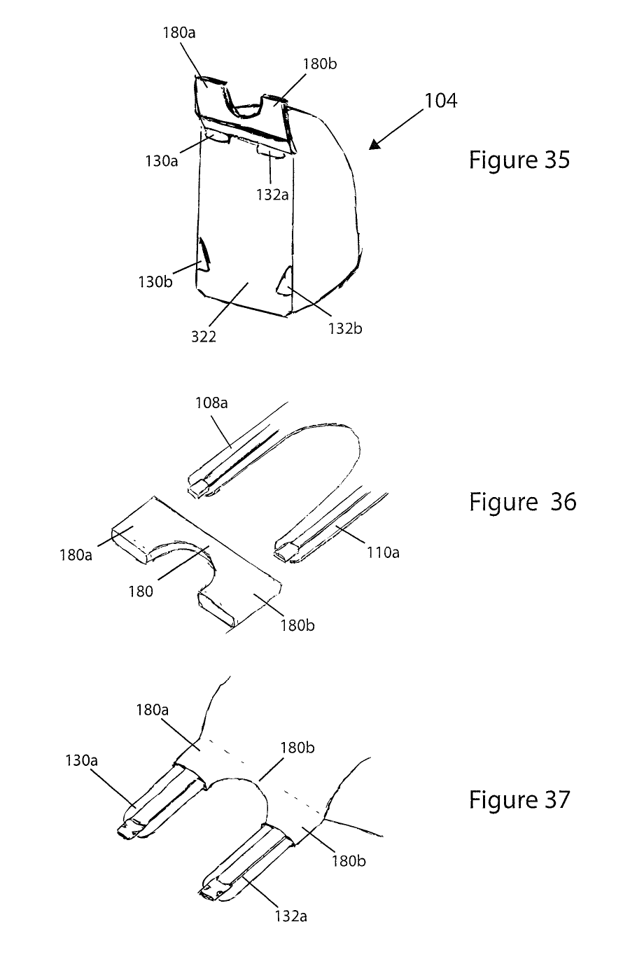

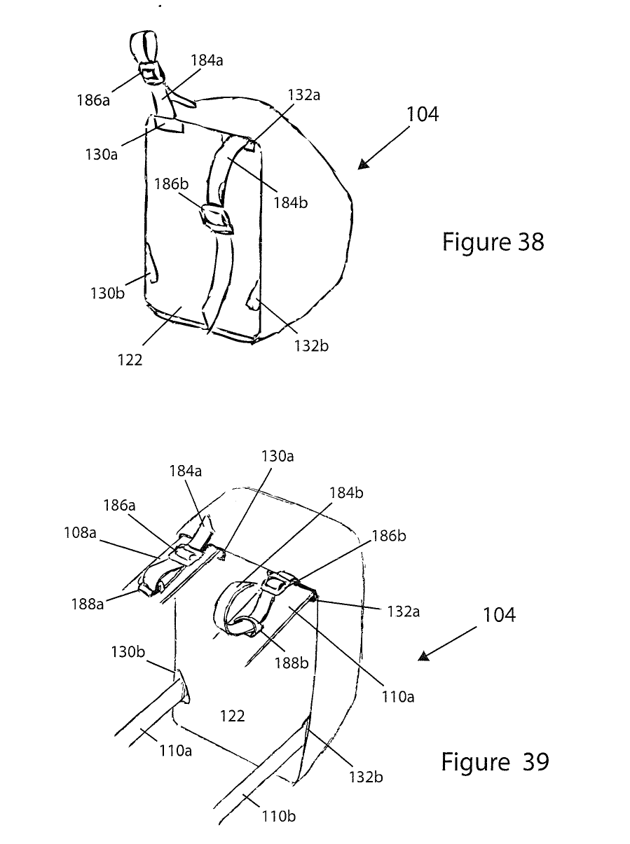

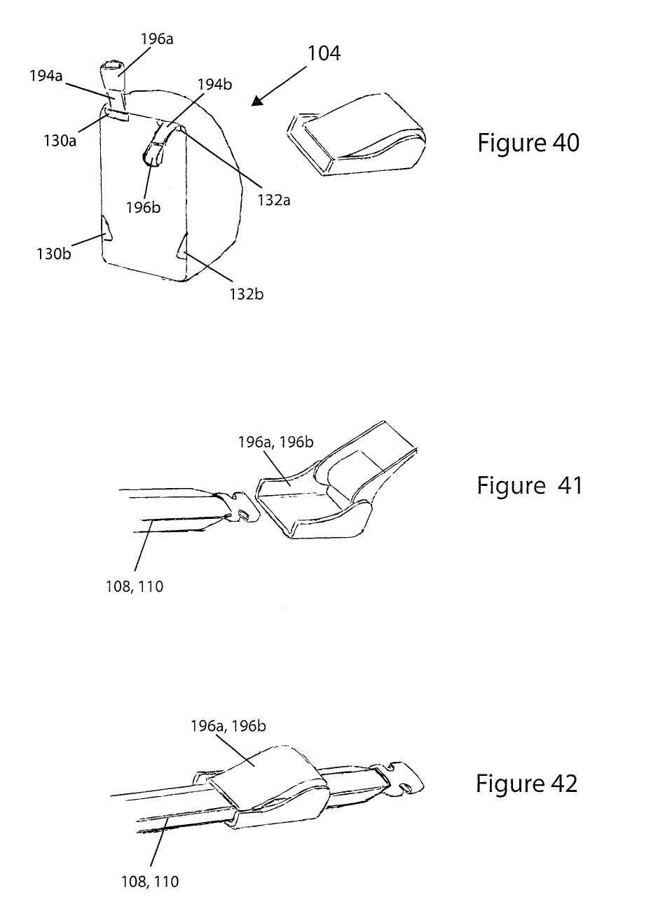

FIGS. 33 and 34 show a load carrying system 500 according to another embodiment. The load carrying system 500 includes a first pack 502 and a second pack 504. As described in detail below, the first pack 202 and the second pack 204 can be assembled and connected to form a load carrying system, which can be carried on a person's waist. The first pack 502 includes a body 506 defining one or more storage compartment, and a hip or waist strap 508. Because the first pack 502 has only one waist strap 508, it may be carried on a person's waist. Such packs are commonly referred to as fanny packs. The strap 508 includes a first section 508a and a second section 508b. The first section 508a is connected or attached at one end to a first side of the body 506. At the opposite end, the first section 508a includes a first mating part 512a of a fastener 512. The second section 508b is connected or attached at one end to a second side of the body 506 that is opposite to the first side. At the opposite end, the second section 508b includes a second mating part 512b of the fastener 512. The strap 508 forms a horizontal loop with the body 506 when the first mating part 512a and the second mating part 512b are mated or connected. The fastener 512 may be similar to the fastener 112 or 114 of the load carrying system 100.

The second pack 504 includes a body 520 defining one or more storage compartments. The body 520 includes a back panel 522 and a front panel 524. Access to the interior of the body 520 can be provided by an opening in the front panel 524, or at least partial removal of the front panel 524 from the body 520. For example, the front panel 524 may be partially removed from the body 520 with a zipper 528. The zipper 528 may be located anywhere on the body 520 to allow access to the interior of the body 520. The zipper 528 may be located on three sides of the front panel 524, thereby allowing access to the entire interior of the body 520.

The back panel 522 includes a first slot 530a and a second slot 530b. The slots 530a and 530b extend through the back panel 522 so as to provide openings from the interior of the body 520 to the outside of the back panel 522. The slots 530a and 530b are configured to accommodate insertion of the strap 508 of the first pack 502 as described in detail below.

A person provided with the load carrying system 500 can use the first pack 502 to carry objects inside the body 506. The second pack 504 is an optional feature of the load carrying system 500 that may be used when needed. Accordingly, the second pack 504 may be stowed when not in use. When the person wishes to use the second pack 504, he or she can assemble the pack 502 with the pack 504 to form the load carrying system 500. To do so, the front panel 524 of the second pack 504 is opened with the zipper 528 to provide full access to the interior of the second pack 504. To assemble first pack 502 with the second pack 504, the fastener 512 is unfastened to separate the strap 508 into strap sections 508a and 508b. Subsequently, the strap sections 508a and 508b are inserted and passed through the slots 530a and 530b, respectively, from inside of the body 520 of the second pack 504. The straps are fully pulled through their corresponding slots until the first pack 502 is completely inside the second pack 504 and abuts the inner side of the back panel 522 of the second pack 504. Accordingly, the first pack 502 should preferably be smaller or at most be nearly the same size as the interior dimensions of the back panel 522 so that the first pack 502 can fit inside the second pack 504 as described above. To complete the assembly process, the first mating part 512a is connected or mated to the second mating part 512b to secure the fastener 512. Thus, the strap 508 completes a loop with the back panel 522 of the second pack 504. The person can then carry both packs 502 and 504 on his or her waist with the waist strap 508, while utilizing the load carrying capabilities of both packs 502 and 504.

In the above embodiments, each strap of the first pack passes through a corresponding slot in the second pack. Accordingly, substantially the entire weight of the second pack may be transferred to the straps at the second slots or the areas around the second slots. Therefore, the slots experience forces that may cause tears, rips, breakage or other damage to the back panel of the second pack. FIGS. 35-42 show various embodiments or reinforcing the second pack and/or the straps of the first pack around the slots. The embodiments of FIGS. 35-42 are applicable to all of the load carrying system embodiments of the disclosure. These embodiments, however, are described below with respect to the load carrying system 100.

Referring to FIGS. 35-37, which shows the second pack 104 from the load carrying system 100, the second pack 102 includes a pair of sleeves 180a and 180b at the slots 130a and 132a, through which the straps 108a and 110a of the first pack 102 are passed as shown in FIGS. 36 and 37. The sleeves 180a and 180b may be connected as shown in FIGS. 35-37 to form a unitary sleeve 180, so that the forces exerted on the slots 130a and 132a can be distributed through the sleeve 180. Another sleeve or a pair of sleeves can be provided for the slots 130b and 132b of the second pack 104. The sleeve 180 may be an integral part of the second pack 104 for distribution of forces from the straps 108a and 108b of the first pack 102 to the second body 104.

Referring to FIGS. 38 and 39, which show the second pack 104 from the load carrying system 100, the second pack 104 includes a reinforcing strap 184a at the slot 130a and a reinforcing strap 184b at the slot 132a. Each of the reinforcing straps 184a and 184b includes a buckle 186a and 186b, respectively. Furthermore, the straps 108a and 110a of the first pack 102 include receiving loops 188a and 188b for receiving the reinforcing straps 184a and 184b respectively. When the straps 108a and 110a of the first pack 102 are passed through the slots 130a and 132a, the reinforcing straps 184a and 184b are passed through the loops 188a and 188b, respectively. The straps 184a and 184b are then returned back toward the slots 130a and 132a and fastened to the buckles 186a and 186b, respectively. Accordingly, the forces exerted on the straps 108a and 110a are at least partly diverted and/or transferred to the body 120 of the second pack 104 instead of being mostly transferred to the slots 130a and 132a. The second pack 104 may also includes reinforcing straps as described above at the slots 130b and 132b.

Referring to FIGS. 40-42, which show the second pack 104 from the load carrying system 100, the second pack 102 includes a reinforcing strap 194a at the slot 130a and a reinforcing strap 194b at the slot 132a. Each of the reinforcing straps 194a and 194b includes a frictionally latching buckle 196a and 196b, respectively. When the straps 108a and 110a of the first pack 102 are passed through the slots 130a and 132a, the reinforcing straps 184a and 184b are passed through the buckles 196a and 196b and securely connected to the straps 194a and 194b by latching the buckles 196a and 196b, respectively. Accordingly, the forces exerted on the straps 108a and 110a are at least partly diverted and/or transferred to the body 120 of the second pack 104 instead of being mostly transferred to the slots 130a and 132a. The second pack 104 may also includes reinforcing straps as described above at the slots 130b and 132b.

Although not shown, other reinforcing devices or methods may be used. Each of the slots may have reinforcement stitching or extra fabric or other rigid or flexible reinforcing materials at and/or around the slot. Each slot may include a plastic or a metal grommet for reinforcement. Furthermore, the back panel of each pack may include extra fabric or rigid and/or flexible support by which the slots are reinforced.

The first and/or second packs according to the disclosure can be made out of any materials suited for the packs' intended application, such as education, sports, mountaineering, military, etc. For example, military versions of the packs may be made out of mil-spec ballistic nylon. Civilian packs may require weather proofing materials or netting for use with water sports. The first and/or second packs may include material to provide different levels of rigidity depending on the intended application to increase comfort, distribute weight, and/or to provide protection for the user from items stored inside the packs or external objects. The preferred rigidity of the first pack and/or the second pack may be achieved by using semi-rigid materials such as neoprene or foam, to more rigid materials such as plastics, composites, and/or even metals. The type and/or the amount of materials chosen for providing the preferred rigidity may depend upon the intended application of the packs, size of the packs, and/or the weight intended to be carried by the packs. For example a light pack may not require any rigid material, but a large pack for use in mountaineering or extended hikes may require a greater level of rigidity. The placement of the rigid materials depends on the function of the first pack and/or the second pack. The shape of the rigid material may be determined so as to provide an optimum collapsed configuration for the packs and/or an optimum comfort for the user.

Although a particular order of actions is described above for the load carrying system, these actions may be performed in other temporal sequences. For example, two or more actions described above may be performed sequentially, concurrently, or simultaneously. Alternatively, two or more actions may be performed in reversed order. Further, one or more actions described above may not be performed at all. The apparatus, methods, and articles of manufacture described herein are not limited in this regard.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A load carrying system comprising:
a first pack having at least one strap with a first section and a second section configured to be detachably connectable to form a loop for carrying the first pack;
a second pack having at least a first slot and a second slot extending through the second pack;
wherein the first pack and the second pack define a first load carrying configuration when the first pack and the second pack are usable separately and independent of each other to carry a corresponding load; and
wherein the first pack and the second pack define a second load carrying configuration when the first pack and the second pack are used together, wherein in the second load carrying configuration, the first section of the at least one strap extends from inside the second pack through the first slot to outside the second pack and the second section of the at least one strap extends from inside the second pack through the second slot to outside the second pack, and wherein the first section of the at least one strap and the second section of the at least one strap are connected to form a loop for carrying the first pack and the second pack in the second load carrying configuration.

2. The load carrying system of claim 1, wherein the first slot and the second slot are located on a back panel of the second pack.

3. The load carrying system of claim 1, wherein the second pack comprises a reinforcing structure at or proximate to each of the first slot and the second slot and configured to support each slot in the second load carrying configuration.

4. The load carrying system of claim 1, wherein the second pack comprises a support sleeve at or proximate to each of the first slot and the second slot, and wherein each of the first section and the second section of the at least one strap extends though the corresponding support sleeve in the second load carrying configuration.

5. The load carrying system of claim 1, wherein the second pack comprises support straps at or proximate to each of the first slot and the second slot, and wherein each of the first section and the second section of the at least one strap is attached to the corresponding support strap in the second load carrying configuration.

6. The load carrying system of claim 1, wherein the second pack comprises a back panel having a first section and a second section, wherein the second section is partly removable from the first section, and wherein the first slot and the second slot are in the second section.

7. The load carrying system of claim 1, wherein the second pack comprises a back panel having a support structure configured to at least partly support a load carried in the second pack.

8. The load carrying system of claim 1, wherein the second pack comprises a back panel having a support structure comprising at least one of vertically oriented or horizontally oriented support beams.

9. A load carrying system comprising:
a first pack having a first strap with a first section and a second section being detachably connectable to form a loop, and a second strap having a first section and a second section being detachably connectable to form a loop;
a second pack having a back panel and a first pair of slots and a second pair of slots extending through the back panel;
wherein the first pack and the second pack define a first load carrying configuration when the first pack and the second pack are usable separately and independent of each other to carry a corresponding load; and
wherein the first pack and the second pack define a second load carrying configuration when the first pack and the second pack are used together, wherein in the second load carrying configuration the first pack is located at least partly inside the second pack, each of the first and second sections of the first strap extends from inside the second pack through one of the slots of the first pair of slots to outside the second pack and each of the first and second sections of the second strap extends from inside the second pack through one of the slots of the second pair of slots to outside the second pack, wherein the first section of the first strap and the second section of the first strap are connected to form a first loop for carrying the first pack and the second pack in the second load carrying configuration, and wherein the first section of the second strap and the second section of the second strap are connected to form a second loop for carrying the first pack and the second pack in the second load carrying configuration.

10. The load carrying system of claim 9, wherein the second pack comprises a reinforcing structure at or proximate to each of the first slot and the second slot and configured to support each slot in the second load carrying configuration.

11. The load carrying system of claim 9, wherein the second pack comprises a support sleeve at or proximate to each of the first slot and the second slot, and wherein each of the first section and the second section of the at least one strap extends though the corresponding support sleeve in the second load carrying configuration.

12. The load carrying system of claim 9, wherein the second pack comprises support straps at or proximate to each of the first slot and the second slot, and wherein each of the first section and the second section of the at least one strap is attached to the corresponding support strap in the second load carrying configuration.

13. The load carrying system of claim 9, wherein the back panel comprises a first section and a second section, wherein the second section is partly removable from the first section, and wherein the first pair of slots and the second pair of slots are in the second section.

14. The load carrying system of claim 9, wherein the back panel comprises a support structure configured to at least partly support a load carried in the second pack.

15. The load carrying system of claim 9, wherein the back panel comprises a support structure comprising at least one of vertically oriented or horizontally oriented support beams.

16. A method of providing a load carrying system comprising a first pack having at least one strap with a first section and a second section configured to be detachably connectable to form a loop for carrying the first pack, and a second pack having at least a first slot and a second slot extending through the second pack, wherein the first pack and the second pack define a first load carrying configuration when the first pack and the second pack are usable separately and independent of each other to carry a corresponding load, and wherein the first pack and the second pack define a second load carrying configuration when the first pack and the second pack are used together, the method comprising:
inserting the first section of the strap from inside the second pack through the first slot to outside the second pack;
inserting the second section of the strap from inside the second pack through the second slot to outside the second pack; and
connecting the first section of the strap and the second section of the strap to form a loop for carrying the first pack and the second pack in the second load carrying configuration.

17. The method of claim 16, further comprising:
inserting the first section of the strap through a first support sleeve located at or proximate to the first slot; and
inserting the second section of the strap through a second support sleeve located at or proximate to the second slot.

18. The method of claim 16, further comprising:
connecting the first section of the strap to a first support strap located at or proximate to the first slot; and
connecting the second section of the strap to a second support strap located at or proximate to the second slot.

19. The method of claim 16, wherein inserting the first section of the strap from inside the second pack through the first slot to outside the second pack and inserting the second section of the strap from inside the second pack through the second slot to outside the second pack comprises:
partly removing a second section of a back panel of the second pack from a first section of the back panel of the second pack, wherein the first slot and the second slot are in the second section of the back panel;
inserting the first section of the strap through the first slot to outside the second pack and inserting the second section of the strap through the second slot to outside the second pack; and
connecting the second section of the back panel to the first section of the back panel.

20. The method of claim 16, further comprising:
inserting a first section of a second strap from inside the second pack through a third slot to outside the second pack;
inserting a second section of the second strap from inside the second pack through a fourth slot to outside the second pack; and
connecting the first section of the second strap and the second section of the second strap to form a loop for carrying the first pack and the second pack in the second load carrying configuration.
